(19) United States
(12) Patent Application Publication
(10) Pub. No.: US 2026/0307229 A1
(43) Pub. Date: Oct. 8, 2026

(54) Electric Power Tool Safety Device

(71) Applicants: John Eaton, III, Metairie, LA (US); Joshua Elder, Shenandoah Junction, WV (US)

(72) Inventors: John Eaton, III, Metairie, LA (US); Joshua Elder, Shenandoah Junction, WV (US)

(21) Appl. No.: 18/730,285

(22) PCT Filed: Jan. 18, 2023
(86) PCT No.: PCT/US2023/011045

§ 371 Date: Jul. 18, 2024

Related U.S. Application Data
(60) Provisional application No. 63/300,469, filed on Jan. 18, 2022.

(51) Int. Cl. B25F 5/00; B23D 59/00; B26D 7/22; B27B 17/00

(52) U.S. Cl. CPC B25F 5/00; B23D 59/001; B26D 7/22; B27B 17/00

(57) ABSTRACT

In accordance with embodiments of the invention, a safety device for an electric power tool is provided. The safety device includes a body and a power source. A processing circuit is contained within the body. At least one sensor is connected to the processing circuit and is operable to detect an operational status of an electric power tool. An alert device is connected to the processing circuit and is operable to generate an alert. The processing circuit activates the alert device to generate an alert based on the operational status of the electric power tool detected by the at least one sensor.

### BACKGROUND OF THE INVENTION

### I. Cross-Reference to Related Applications

This application claims benefit of U.S. Provisional Patent Application Ser. No. 63/300,469, filed Jan. 18, 2022, the entirety of which is incorporated by reference as if fully disclosed herein.

### II. Field of the Invention

The present invention relates generally to safety devices for electric power tools.

### III. General Background

In recent years, many power tools have shifted from internal combustion power to battery power. Battery power is advantageous to reduce the number of fossil fuel burning engines contributing to global warming. Battery powered tools are also very quiet, which would seem advantageous, as noise from a job site is reduced. However, this reduced noise level creates a dangerous situation-people nearby a tool often do not know the tool is powered on or in use, leading to increased chances for an accident or an injury. For example, when a gas powered chainsaw is in use, it is very noisy, and people nearby become aware of the use and do not stand under branches being sawed. Contrarily, people do not have this same ability to hear a battery powered saw when it is in use and may unwittingly walk below a branch being sawed. Accordingly, what is needed in the art is a safety device to alert people nearby that a power tool is in use.

### SUMMARY OF THE INVENTION

In accordance with embodiments of the invention, a safety device for an electric power tool is provided. The safety device includes a body and a power source. A processing circuit is contained within the body. At least one sensor is connected to the processing circuit and is operable to detect an operational status of an electric power tool. An alert device is connected to the processing circuit and is operable to generate an alert. The processing circuit activates the alert device to generate an alert based on the operational status of the electric power tool detected by the at least one sensor.

In accordance with embodiments of the invention, a safety device for an electric power tool is provided. The safety device includes a body and a power source. A processing circuit is contained within the body. The safety device includes a plurality of sensors with each sensor of the plurality of sensors connected to the processing circuit. Each sensor of the plurality of sensors is operable to detect an operational status of an electric power tool. An alert device is connected to the processing circuit and is operable to generate an alert. The processing circuit activates the alert device to generate an alert based on the operational status of the electric power tool detected by the sensors.

In accordance with embodiments of the invention, a method for generating an alert when an electric power tool is in use is provided. The method includes a first step of providing a safety device for an electric power tool. The safety device includes a body and a power source. A processing circuit is contained within the body. At least one sensor is connected to the processing circuit and is operable to detect an operational status of an electric power tool. An alert device is connected to the processing circuit and is operable to generate an alert. The method includes a second step of detecting, by operation of the at least one sensor, an operational status of an electric power tool. The method includes a third step of analyzing, by operation of the processing circuit, whether the electric power tool is operating based on the operational status detected by the at least one sensor. The method includes a fourth step of activating, by operation of the processing circuit, the alert device to generate an alert if the electric power tool is operating.

### BRIEF DESCRIPTION OF THE DRAWINGS

The foregoing and other objects, features, and advantages of the invention are apparent from the following detailed description taken in conjunction with the accompanying drawings in which like parts are given like reference numerals and, wherein:

FIG. 1 depicts a perspective view of an electric power tool safety device attached to a chainsaw in accordance with embodiments of the invention.

FIG. 2 depicts a cut away view of an electric power tool safety device contained within a handle of a chainsaw in accordance with embodiments of the invention.

FIG. 3 depicts perspective view of an electric power tool safety device attached to a chainsaw with electrical leads into the chainsaw in accordance with embodiments of the invention.

FIG. 4 depicts perspective view of an electric power tool safety device attached to a chainsaw, a cutaway perspective view of an electric power tool safety device contained within a handle of a chainsaw, and an exploded perspective view of an electrical power tool safety device connected between an electrical power tool and the battery of the electrical power tool in accordance with embodiments of the invention.

FIG. 5 depicts cutaway view of an electric power tool safety device contained within a handle of a chainsaw in accordance with embodiments of the invention.

FIG. 6 depicts a front view of an electric power tool safety device attached to a chainsaw in accordance with embodiments of the invention.

FIG. 7 depicts a perspective view of an electric power tool safety device attached to a chainsaw in accordance with embodiments of the invention.

FIG. 8 depicts a perspective view of an electric power tool safety device attached to a chainsaw in accordance with embodiments of the invention.

FIG. 9 depicts a front view of an electric power tool safety device attached to a chainsaw in accordance with embodiments of the invention.

FIG. 10 depicts an exploded perspective view of an electrical power tool safety device connected between an electrical power tool and the battery of the electrical power tool in accordance with embodiments of the invention.

FIG. 11 depicts a perspective view of an electric power tool safety device in accordance with embodiments of the invention.

FIG. 12 depicts a perspective view of an alert siren of electric power tool safety device attached to an electric power tool in accordance with embodiments of the invention.

FIG. 13 depicts a perspective view of an electric power tool safety device in accordance with embodiments of the invention.

FIG. 14 depicts an electric power tool safety device having an optical sensor and an alert device operable to generate a sound in accordance with embodiments of the invention.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention that may admit to other equally effective configurations. It is contemplated that features of one configuration may be beneficially incorporated in other configurations without further recitation.

### DETAILED DESCRIPTION

The embodiments of the disclosure will be best understood by reference to the drawings, wherein like parts are designated by like numerals throughout. It will be readily understood that the components, as generally described and illustrated in the Figures herein, could be arranged and designed in a wide variety of different configurations or be entirely separate. Thus, the following more detailed description of the embodiments of the system and method of the disclosure, as represented in the Figures is not intended to limit the scope of the disclosure, as claimed, but is merely representative of possible embodiments of the disclosure.

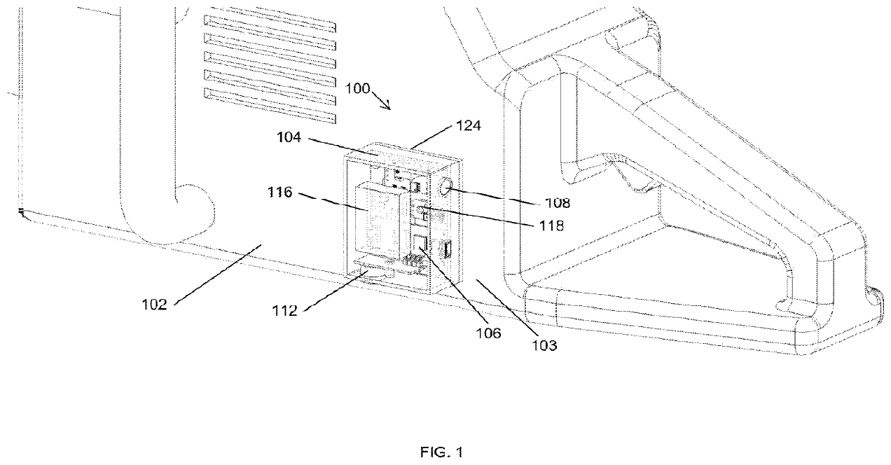

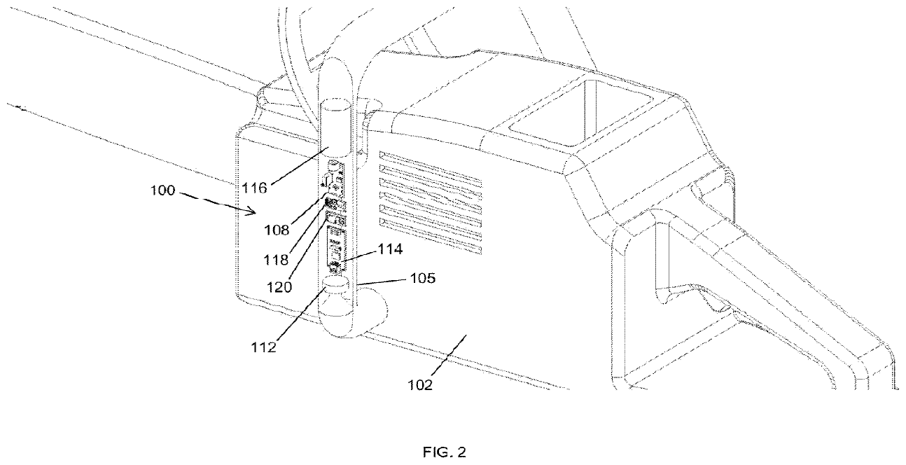

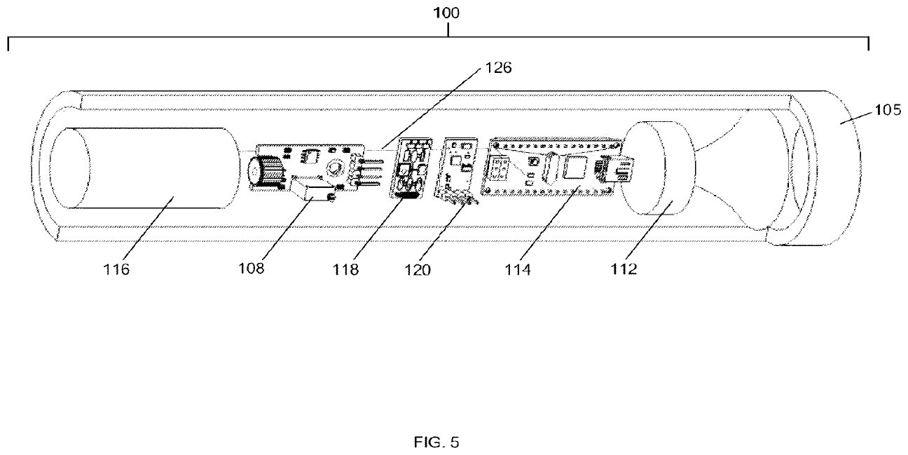

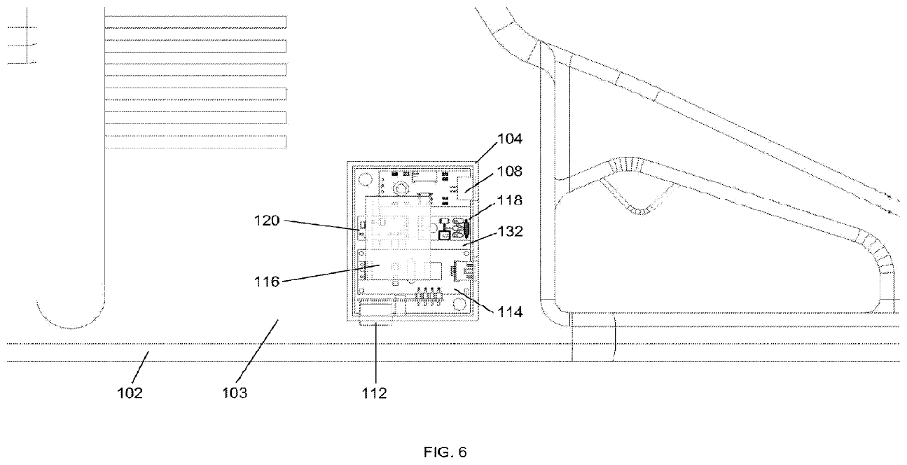

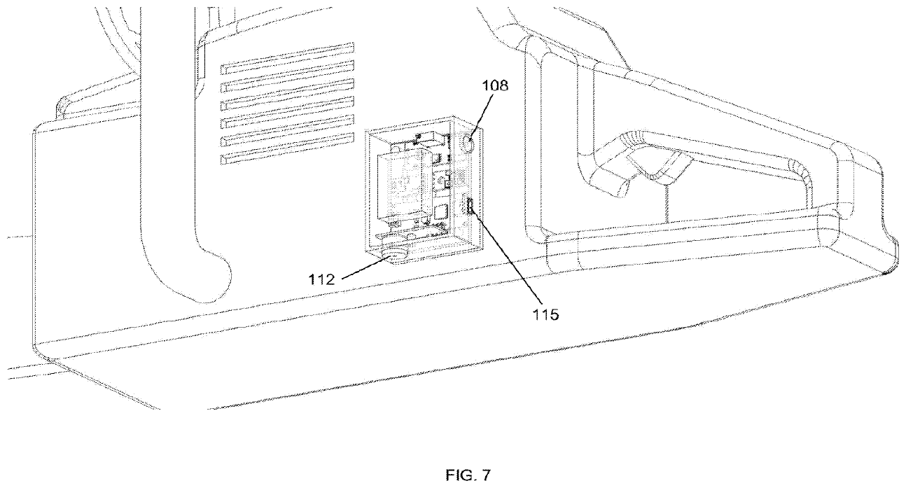

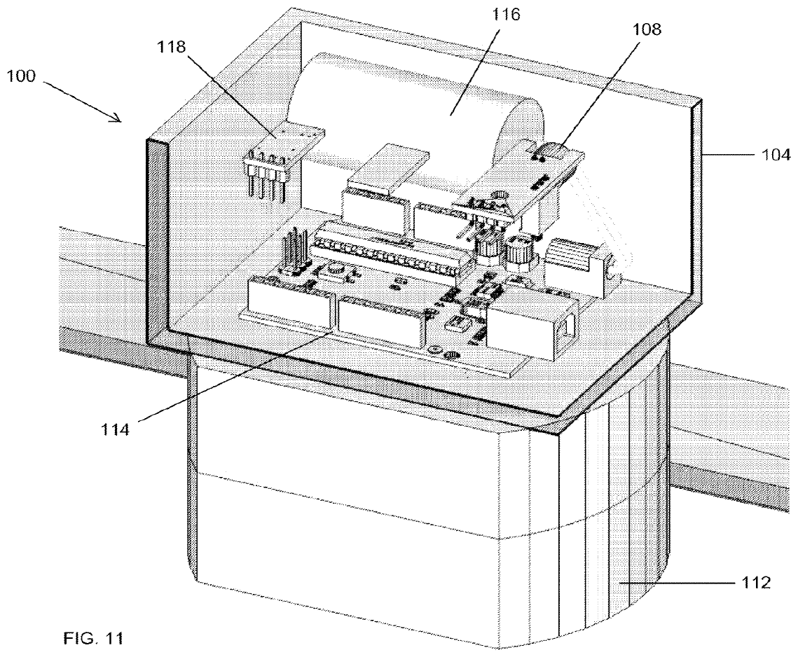

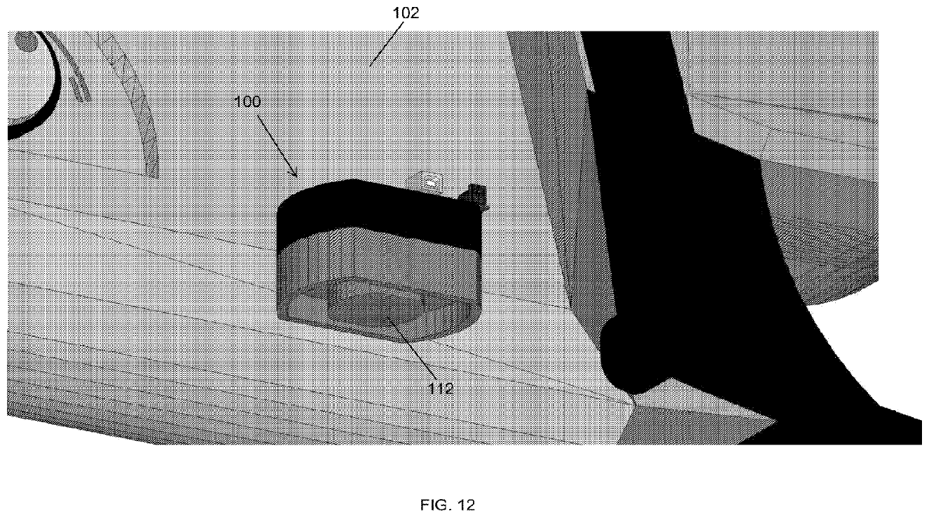

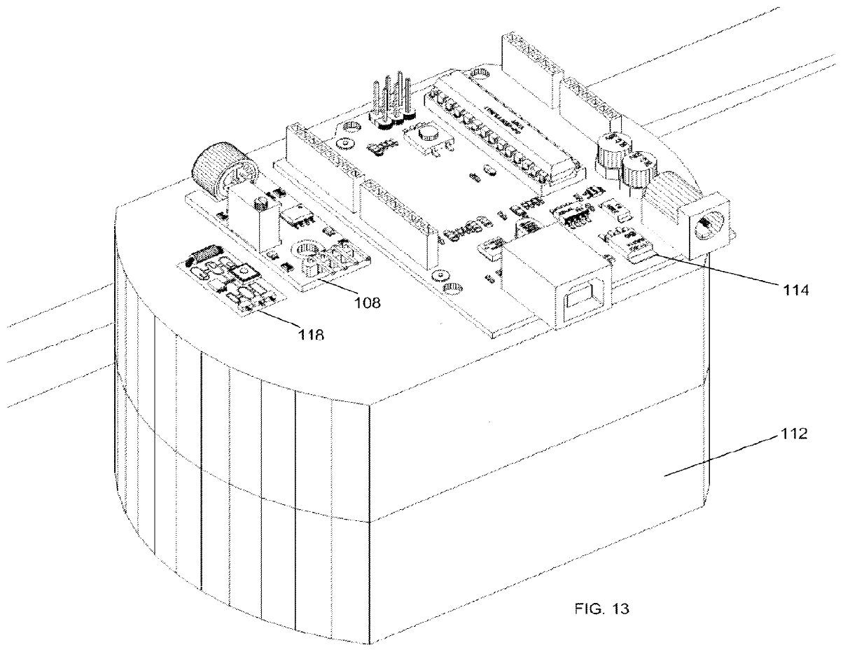

In accordance with embodiments of the invention, a safety device 100 for an electric power tool 102 is provided, as illustrated in FIGS. 1-14. Power tool 102 may be a chainsaw, hand saw, lawn mower, edger, power saw, a circular saw, or any other power tool that is powered by a battery. The alert device 100 includes a body 104. A processing circuit 106 is contained within the body 104. The processing circuit 106 may be any suitable microcontroller, such as a Microchip microcontroller, an Arduino microcontroller, or a Raspberry Pi computer, for example, operable for processing sensor inputs and controlling outputs. A sensor is connected to the processing circuit 106 and operable to detect an operational status, such as whether the electric power tool 102 is operating, on, off, or idle. The sensor may be operable to detect motion or sound of a chain 110 of a chainsaw, motion or sound of a power tool bit, or the position of a trigger 111 of power tool 102, for example. Some examples of the sensor are a sound sensor 108, an optical sensor, a motion sensor, an infrared sensor, a vibration sensor 118, magnetometer or Hall Effect sensor 120 to detect electric current, or wiring connected to the trigger 111 of the power tool 102 operable to detect the position of the trigger 111. An alert device 112 is connected to the processing circuit 106 and is operable to generate an alert. The alert device 112 may be a light or a sound emitting device (as illustrated in FIG. 2) to play a noise or a recording indicating that the power tool 102 is in use or powered on, for example. The processing circuit 106 is operable to activate the alert device 112 to generate an alert based on the operational status of the electric power tool 102 detected by the sensor 108. In an exemplary operation, if the power tool 102 is in use, the sensor 108 will send the processing circuit 106 a signal that the device is in use. The processing circuit 106 will then activate the alert device 112 to generate a warning signal, such as a sound, to alert people nearby that the power tool 102 is in use. Wiring 126 (FIG. 5) illustrates an exemplary connection of these components. As illustrated, the body 104 defines opening for sound sensor 108 and alert device 112.

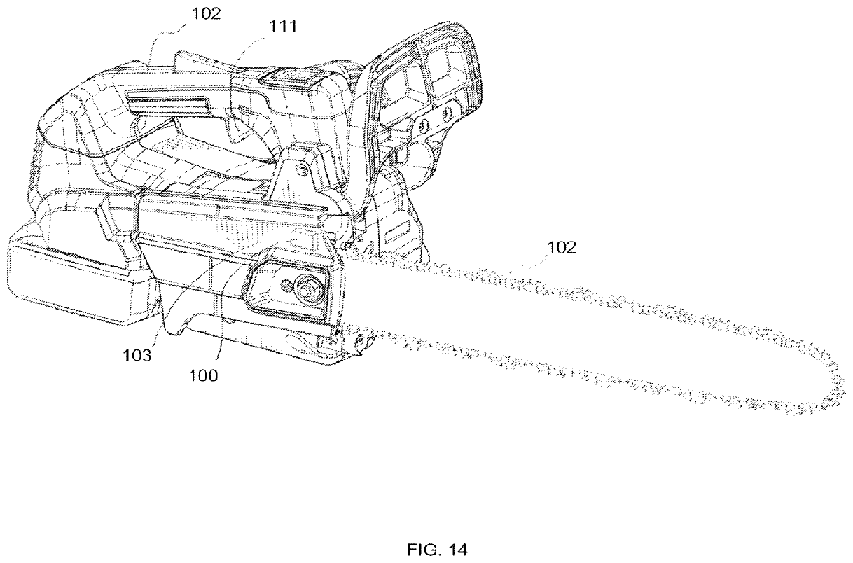

In some embodiments, the body 104 may be attached to an exterior surface 103 of the power tool 102, as illustrated in FIG. 1 by adhesive pad 124. The body 104 may be positioned adjacent to the cutting element, such as chain 110 (or bit) of the power tool 102 (FIG. 14), adjacent to the trigger 111 of the power tool 102, or on any exterior surface of the power tool 102 as required by the embodiment. Any suitable attachment means may be utilized, including bolts native to the power tool 102. The alert device 100 includes a power source operable to power the components of the alert device 100, including the processing circuit 106, the sensor 108, and the alert device 112, for example. Power source may be a battery 116 (as illustrated in the Figures) or a wired connection to the power tool 102. Battery 116, such as a rechargeable battery, can be either fixed or removable, for example. The safety device 100 may have solar panels or any other suitable power source, for example. In some embodiments, the battery capacity may match the battery capacity of the tool 102 to provide ample power to the safety device 100 and processing circuit 106.

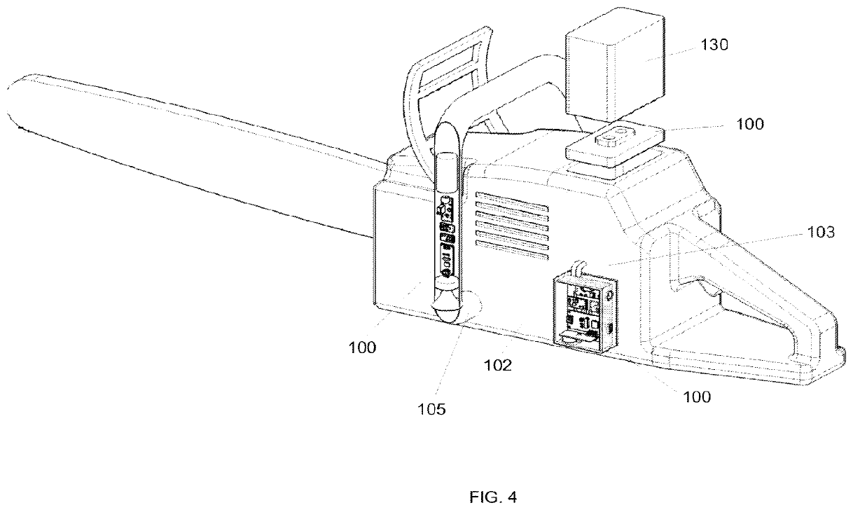

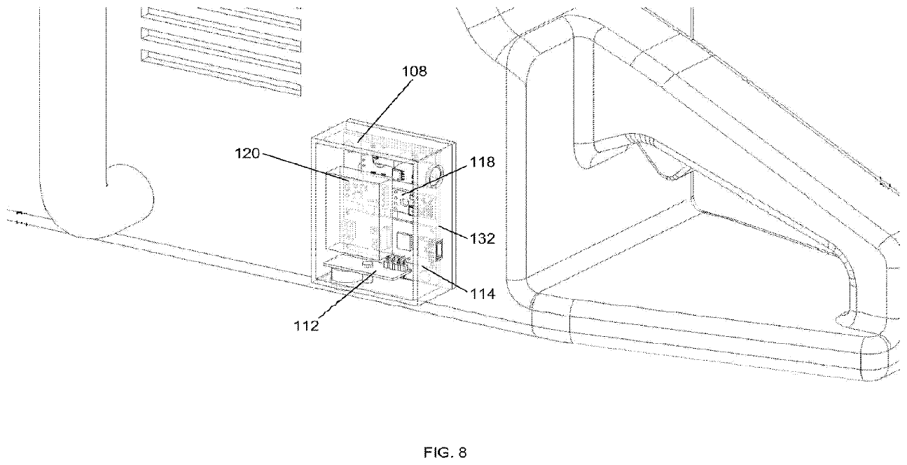

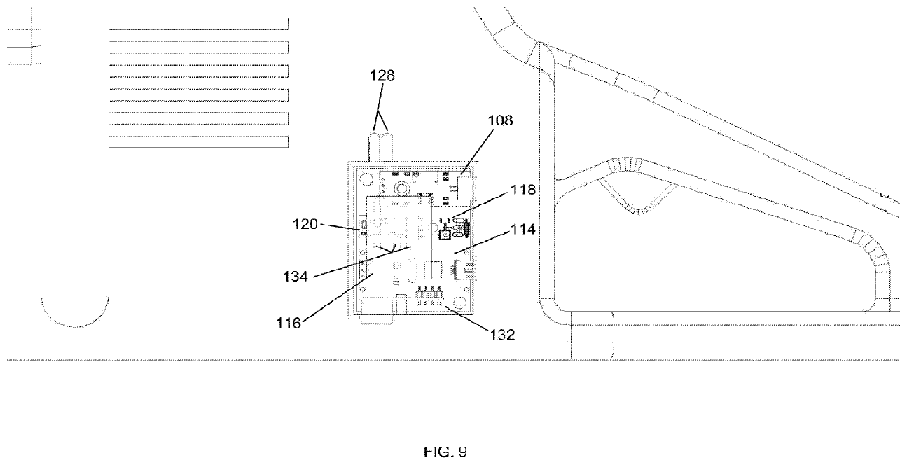

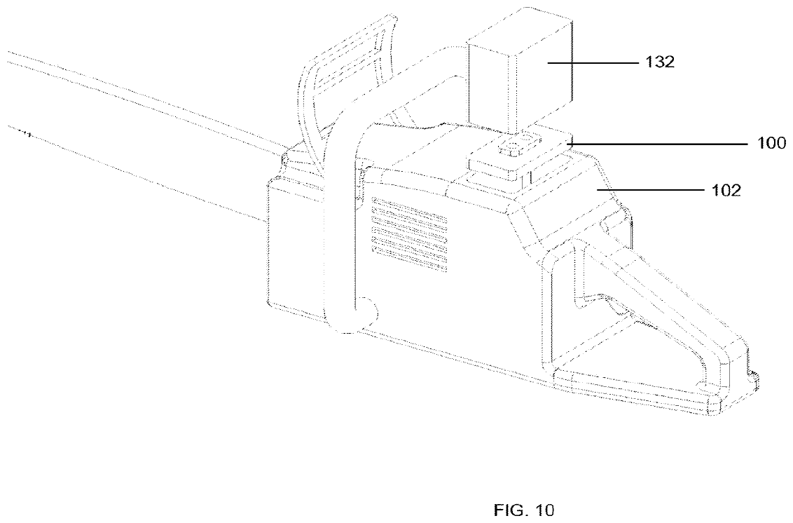

As illustrated in the embodiments in the Figures (e.g., FIGS. 2 and 5), the safety device 100 may be a self-contained unit within the body 104. As one skilled in the art will understand, the safety device 100 utilizes basic controls, such as processing unit 106, to receive input signals, determine the needed response, and activate the siren or alarm device 112 appropriately. Other features may be included in the control system, such as varying the output volume according to environmental factors. The control system will also process signals of the microphone inputs. In some embodiments, the processing module and sensor modules will be separate devices. In some embodiments, the control system may be a single board design, such as circuit board 132 with board pathways 134 as illustrated in FIGS. 8-9, containing the microcontroller, all necessary sensors, and alert devices on one board. In one embodiment, as illustrated in FIGS. 4 and 10, the safety device is attached to the device between the power tool 102 and the power tool battery 130, deriving power from the power tool battery 130. In embodiments where the safety device 102 is wired or connected to the power or battery of the tool 102, the safety device 102 may not need its own battery.

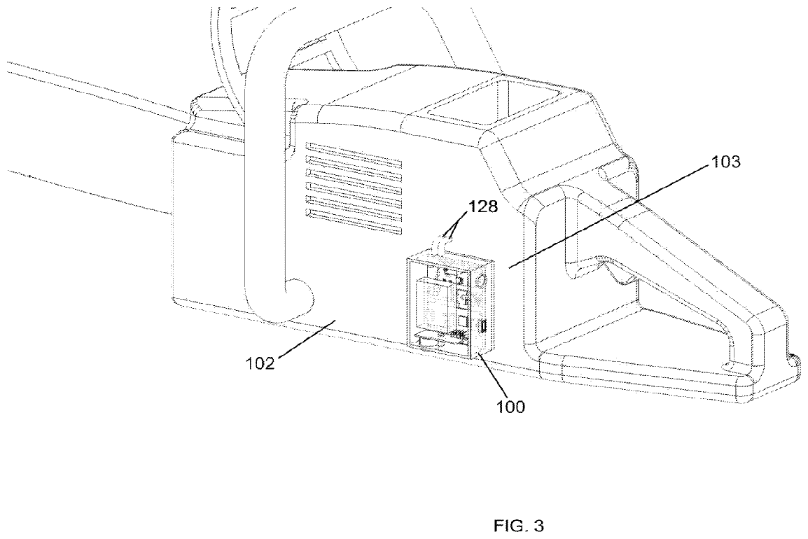

An object of the invention is to sound the alert device 112 while the power tool 102 is operating. In one embodiment, when the safety device 100 is included in the manufacturing of a power tool 102 device, this safety device 100 may be incorporated into the electronics design of the tool 102, such as the trigger 111 of the tool 102, via wiring 128 (FIG. 3), for example. In one embodiment, the safety device 100 is an add-on device that does not require access to the internal components of the power tool 102. One or more sensors may be used detect tool 102 operation. Using a single sensor increases the risk of false activation of the alarm, so the design will likely include multiple sensor types to address this concern. The logic control will trigger the siren if multiple sensors agree that the tool is in operation. Selecting a sensor type and sensitivity that correctly determines if the tool is operational without nuisance activation of the alarm may vary depending on the type of tool. For example, in an embodiment including three sensors, such as a noise sensor 108, a vibration sensor 118, and a magnetic field sensor 120, the processing circuit 106 may confirm that two or three sensors are detecting operation of the power tool 102. Some embodiments of the safety device may have multiples of the same types of sensors. This redundancy may be important in preventing false alerts. Alternatively, the processing circuit 106 may confirm that at least one sensor detects operation of the power tool 102 in an embodiment where there is concern that the sensors may fail, such as due to harsh environment and wear and tear. The alert device 112 may be programmed to indicate a low battery or a defective sensor or any other anomaly, for example. Processing circuit 106 may include USB port 115, accessible through and opening defined by the housing 104 as illustrated, to enable programming of the safety device 100.

In embodiments of the safety device 100 including a microphone or noise sensor 108, complex signal processing may be necessary to isolate the sounds specific to the tool in use, as an alert may triggered by external sources, e.g., shouting or another tool, for example. It is also possible that the siren-microphone combination could be self-perpetuating, leading to a scenario where the siren remains active even after the tool is switched off. Signal processing may be implemented to ignore the siren sound, for example. A configuration to pulse the siren, ignoring the microphone input while the siren is active, and reading the environmental volume between pulses, may avoid the self-perpetuating issue. One advantage of noise sensing is the ability to include automatic volume adjustment based on the tool noise volume, since different tools will have varying degrees of loudness. This is an advantage of including a microphone sensor.

In some embodiments, a vibration sensor 118 is implemented to detect tool operation. In one embodiment, a vibration sensor 118 may be used in combination with a microphone/sound sensing device. A design consideration is where and how the sensor is mounted. Vibrations could be more easily detected in certain orientations, depending on the tool. This requires some consideration on how rigidly the body 104 is mounted to the tool; however, it would likely detect the vibrations with most mounting configurations. As for all sensors, the concern here is nuisance triggering, such as the alarm sounding while driving down the highway, for example. As such, complex signal processing may be utilized to distinguish unique vibrations associated with conditions for alerts.

In some embodiments, the safety device 100 may be fabricated integrally within the power tool 102, such as in the handle 105 of the power tool 102, as illustrated in FIG. 2. The sensor 108 and the alert device 112 may be connected to a central processing circuit 114 of the power tool 102 and powered by a battery 105 of the power tool 102. The central processing circuit 114 of the power tool 102 is operable to activate the warning device 112 to generate an alert based on the operational status of the electric power tool 102 detected by the sensor 108.

In one embodiment, a magnetometer or current detection sensor 120 may be used to detect when current is flowing to the motor or in the wiring of the power tool 102. This could be accomplished by using a magnetometer or Hall Effect sensor placed near enough to the active components to detect magnetic fields. This could provide one of the most direct sensor readings to determine if the tool is operational.

In one embodiment, as illustrated in FIG. 3, the alert device 100 is operable to generate an alert when the trigger 111 of the power tool 102 is pulled. When the trigger 111 is pulled, a circuit 118 is closed to activate the chain 110. The alert device 100 can be wired by wires 121 to the circuit 118 to generate an alert when the circuit is closed. Specific configurations of the wiring can vary depending on the circuitry, voltage, and current of the circuit 118. With some tools, enough power may be generated in the circuit 118 to power the alert device 100. In some embodiments, the sensor 108 will detect that the circuit 118 has been closed but will not be powered by the circuit 118.

As illustrated, the body 104 may be positioned in a way to direct the siren 108 in the appropriate direction, downward, for example, as to not impede the user's operation of the tool 102. The components used are small in comparison to power tools and can be arranged in a number of ways. As an add-on device, it will be a weatherproof box, body 104, that is mounted to the tool 102. If incorporated into the design of the tool 102, the components of the exemplary design are small enough that the device could be hidden inside of the tool, such as in the handle of the tool, as illustrated in FIG. 2.

In accordance with embodiments of the invention, a method 200 for generating an alert when an electric power tool 102 is in use is provided. The method 200 includes a first step 202 of providing a safety device 100 for an electric power tool 102. The safety device 100 includes a body 104 and a power source 116. A processing circuit 114 is contained within the body 104. At least one sensor 108 is connected to the processing circuit 114 and is operable to detect an operational status of an electric power tool 102. An alert device 112 is connected to the processing circuit 114 and is operable to generate an alert. The method 200 includes a second step 204 of detecting, by operation of the at least one sensor 108, an operational status of an electric power tool 102. The method 200 includes a third step 206 of analyzing, by operation of the processing circuit 114, whether the electric power tool 102 is operating based on the operational status detected by the at least one sensor 108. The method includes a fourth step 208 of activating, by operation of the processing circuit 114, the alert device 112 to generate an alert if the electric power tool 102 is operating.

In one embodiment of the method 200, the safety device includes at least two sensors connected to said processing circuit. The at least two sensors are operable to detect an operational status of an electric power tool. The method may further include the step 210 of confirming, by operation of the processing circuit, whether the electric power tool is operating based on the operational status detected by each sensor of said at least two sensors.

Human psychology plays an important role in alerts for dangerous situations, as humans are conditioned to react to certain sounds, such as backup alerts from trucks, fire alarms in buildings, and the sound of a two stroke gas engine powering a saw. In some embodiments, the alert device 112 may be programmed to play alerts to mimic that of a gas powered chain saw or a two stroke gas engine to utilize a person's natural disposition to avoid areas where these noises are emanating. Two or more alert devices, such as a plurality of speakers, may be utilized to create more complex sounds.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A safety device for a portable electric power tool, comprising:
a body;
a power source;
a processing circuit contained within said body;
at least one sensor, said at least one sensor connected to said processing circuit, said at least one sensor operable to detect an operational status of a portable electric power tool;
an alert device, said alert device connected to said processing circuit, said alert device operable to generate an alert; and
wherein said processing circuit activates said alert device to generate an alert based on said operational status of said portable electric power tool detected by said at least one sensor.

2. The safety device of claim 1, wherein said power source is a battery.

3. The safety device of claim 1, wherein said power source is said portable electric power tool.

4. The safety device of claim 1, wherein said sensor is a sound sensor.

5. The safety device of claim 1, wherein said at least one sensor is a motion sensor.

6. The safety device of claim 1, wherein said at least one sensor is a vibration sensor.

7. The safety device of claim 1, wherein said at least one sensor is a magnetic current sensor.

8. The safety device of claim 1, wherein said at least one sensor is operable to detect a position of a trigger of said portable electric power tool.

9. The safety device of claim 1, wherein said alert device is operable to emit a sound.

10. The safety device of claim 1, wherein said alert device is operable to emit a light.

11. A safety device for a portable electric power tool, comprising:
a body;
a power source;
a processing circuit contained within said body;
a plurality of sensors, each sensor of said plurality of sensors connected to said processing circuit, each of said plurality of sensors operable to detect an operational status of a portable electric power tool;
an alert device, said alert device connected to said processing circuit, said alert device operable to generate an alert; and
wherein said processing circuit activates said alert device to generate an alert based on said operational status of said portable electric power tool detected by said sensors.

12. The safety alert device of claim 11, wherein said processing circuit activates said alert device to generate an alert based on said operational status of said portable electric power tool detected by each sensor of said plurality of sensors.

13. The safety alert device of claim 11, wherein said processing circuit activates said alert device to generate an alert if each sensor of said plurality of sensors detect said portable electric power tool is operating.

14. The safety device of claim 11, wherein at least one sensor of said plurality of sensors is a sound sensor.

15. The safety device of claim 11, wherein at least one sensor of said plurality of sensors is a motion sensor.

16. The safety device of claim 11, wherein at least one sensor of said plurality of sensors is vibration sensor.

17. The safety device of claim 11, wherein at least one sensor of said plurality of sensors is a magnetic current sensor.

18. A method for generating an alert when a portable electric power tool is in use, comprising:
providing a safety device for a portable electric power tool, said safety device comprising:
a body;
a power source;
a processing circuit contained within said body;
at least one sensor, said at least one sensor connected to said processing circuit, said at least one sensor operable to detect an operational status of a portable electric power tool; and
an alert device, said alert device connected to said processing circuit, said alert device operable to generate an alert;
detecting, by operation of said at least one sensor, an operational status of a portable electric power tool;
analyzing, by operation of said processing circuit, whether said portable electric power tool is operating based on said operational status detected by said at least one sensor; and
activating, by operation of said processing circuit, said alert device to generate an alert if said portable electric power tool is operating.

19. The method of claim 18, wherein said safety device comprises at least two sensors, said at least two sensors connected to said processing circuit, said at least two sensors operable to detect an operational status of a portable electric power tool.

20. The method of claim 19, further comprising the step of confirming, by operation of said processing circuit, whether said portable electric power tool is operating based on said operational status detected by each sensor of said at least two sensors.

21. The method of claim 18, further comprising the step of alerting non-users of said portable electric power tool.

22. The method of claim 18, further comprising the step of the alert device emitting a sound that emulates a sound produced by a non-electric power tool.

23. The safety device of claim 1, wherein said alert device is operable to alert non-users of said portable electric power tool.

24. The safety device of claim 1, wherein said alert device is operable to emit a sound that emulates a sound produced by a non-electric power tool.

25. The safety device of claim 11, wherein said alert device is operable to alert non-users of said portable electric power tool.

26. The safety device of claim 11, wherein said alert device is operable to emit a sound that emulates a sound produced by a non-electric power tool.
